(19) United States
(12) Patent Application Publication
(10) Pub. No.: US 2001/0033763 A1
(43) Pub. Date: Oct. 25, 2001

(54) Calibrating an adjustable ergonomic keyboard

(76) Inventors: Mark Goldstein, Katonah, NY (US); Elizabeth Goldstein, Katonah, NY (US); Lawrence Hettinger, Harvard, MA (US)

Correspondence Address: KENYON & KENYON, 1500 K STREET, N.W., SUITE 700, WASHINGTON, DC, 20005, US

(21) Appl. No.: 09/793,894

(22) Filed: Feb. 28, 2001

Related U.S. Application Data
(60) Provisional application No. 60/185,693, filed on Feb. 29, 2000.

(51) Int. Cl. B41J 5/26

(52) U.S. Cl. 400/472; 400/489

(57) ABSTRACT

Method and system to determine an initial suitable configuration of an adjustable keyboard is provided. This system may include a pronation gauge wherein the pronation gauge has a readable scale and the readable scale is adapted to indicate a specific degree of pronation for the user's hand depending upon a specific resting orientation of the user's hand within the gauge. This method may include measuring the resting pronation position of the user's first hand and then adjusting the pronation orientation of the ergonomic adjustable keyboard to a position that coincides with the measurement of the pronation position of the user's hand.

### RELATED APPLICATION

This application claims the benefit of U.S. provisional application no. 60/185,693, filed Feb. 29, 2000, and incorporates that provisional application herein by reference.

### BACKGROUND

Repetitive Stress Injury (RSI) is an injury to the body that may be caused by the constant repetition of a specific motion over time. Typing or data entry on a standard flat computer keyboard is a common source of RSI as a typist is forced to configure his hands and fingers to the keyboard, increasing the amount of stress placed on his hands during each keystroke. Moreover, in addition to increasing the risk of RSI, typing on a flat keyboard can also promote fatigue and discomfort in the typist as he is forced to adjust his body to comply with the unnatural linear and flat orientation of the keyboard.

To combat these problems keyboards have become adjustable and can now more directly align themselves with the physical attributes of their users. One example of an adjustable ergonomic keyboard is the Goldtouch® keyboard manufactured by Goldtouch Technologies, Inc. This keyboard adjusts to suit the individual physical characteristics of the user. This keyboard has two connected alphanumeric sections that may be adjusted and locked in a position that is the most comfortable and relaxed for the muscles and tendons of the fingers, hands, wrists, arms, and shoulders of the user.

Adjustable keyboards are typically adjusted by the individual users. Some users, however, whether knowingly or not, do not fully and properly adjust their ergonomic keyboards to meet their individual ergonomic needs. For example, rather than placing the keyboard in the most ergonomically efficient position, users, restricted by their individual paradigms, have allowed the keyboards to remain too flat and have allowed the pivoting sections of keyboards to remain too close together. Hindered by the suggestion of existing flat keyboards, users have not adjusted adjustable keyboards aggressively enough.

### SUMMARY OF THE INVENTION

A system for determining an initial suitable configuration of an adjustable keyboard for an individual user is provided. This system may include a pronation gauge wherein the pronation gauge has a readable scale that is adapted to indicate a specific degree of pronation for the user's hand depending upon a specific resting orientation of the user's hand within the gauge.

A method of determining an initial suitable configuration of an adjustable keyboard for an individual user is also provided. This method may include measuring the resting pronation position of the user's hand and, then, adjusting the pronation orientation of the ergonomic adjustable keyboard to a position that coincides with the measurement of the pronation position of the user's hand.

### BRIEF DESCRIPTION OF THE DRAWINGS

FIG. 1 illustrates a user's hand position on a regular unadjustable computer keyboard.

FIG. 2 illustrates a user's hands typing on an adjustable ergonomic keyboard after it has been adjusted by the user in accord with one embodiment of the present invention.

FIG. 3 illustrates a top plan view of a pronation gauge in accord with one embodiment of the present invention.

FIG. 4 illustrates how a user's hand may be inserted into the hand strap of the pronation gauge of FIG. 3 in accord with one embodiment of the present invention.

FIG. 5 illustrates a side view of the pronation gauge of FIG. 3 in a first position.

FIG. 6 illustrates a side view of the pronation gauge of FIG. 3 in a second position.

FIG. 7 illustrates a splay indicator in a first position in accord with one embodiment of the present invention.

FIG. 8 illustrates a splay indicator in a second position in accord with one embodiment of the present invention.

FIG. 9 illustrates a side view of an ergonomic keyboard after it has been adjusted in accord with one embodiment of the present invention.

FIG. 10 illustrates a top plan view of an ergonomic keyboard after it has been adjusted in accord with one embodiment of the present invention.

### DETAILED DESCRIPTION

The present invention uses proprioceptive and anthropometric principles to assist a user in adjusting his adjustable keyboard. In one embodiment, a user may be assisted in adjusting either the height or the splay (or both) of the keyboard. By adjusting the height of a two-section pivoting keyboard, the keyboard may be better suited to align with the natural twist of the user's hands and arms, the user's natural pronation angle. Similarly, by adjusting the angle or splay between the two sections of the keyboard, the keyboard may be better suited to align with the user's individual splay, the natural angle created between the user's hands when they are resting inside his shoulders, as they would normally be during typing.

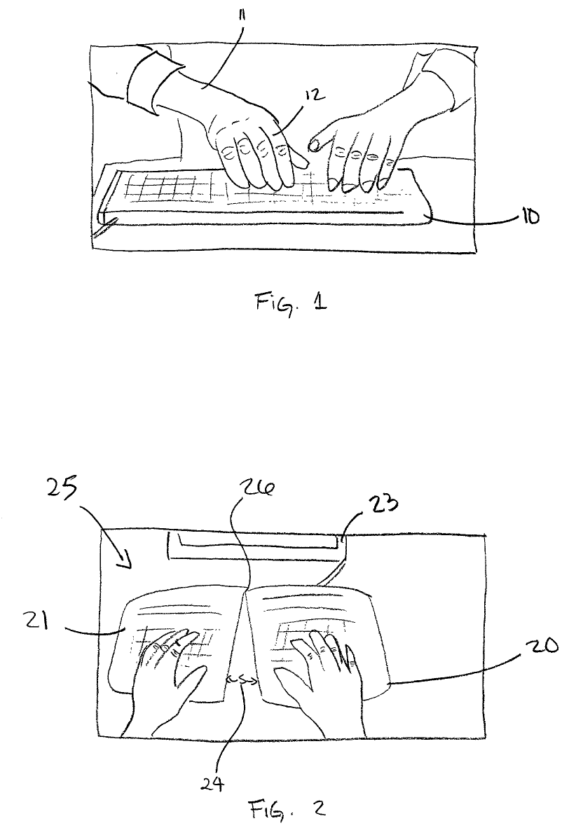

FIG. 1 illustrates a flat non-ergonomic or adjustable computer keyboard 10 being used by a typist. As can be seen, the wrists 11 and fingers 12 of the typist are awkwardly positioned as they strain to meet and depress the keys of the keyboard 10 in order to enter data through the keyboard 10 into a computer (not shown). As is also evident the keyboard is resting flat on the work surface in FIG. 1.

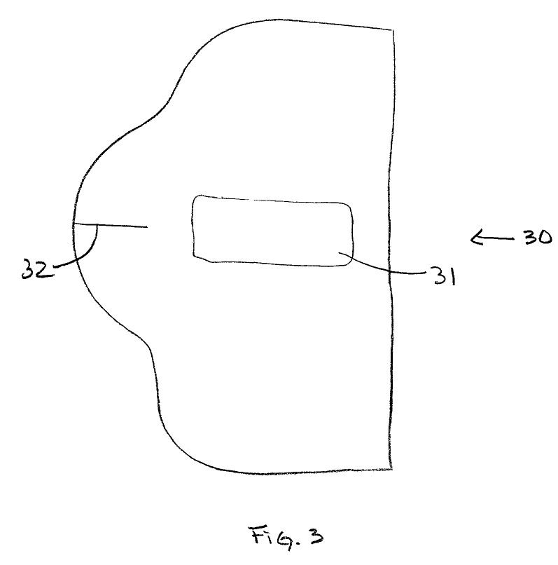

FIG. 2 illustrates an adjustable ergonomic keyboard 25 having a first section 20 and a second section 21. These sections are pivotably connected by the pivoting joint 26 and may be pivoted and locked at various angles or splays 24 from one another. By pivoting and then by locking the two sections at different heights above the work surface and at different splay angles between the sections, the keyboard 25 may be adapted too more comfortably fit a user than a standard flat keyboard.

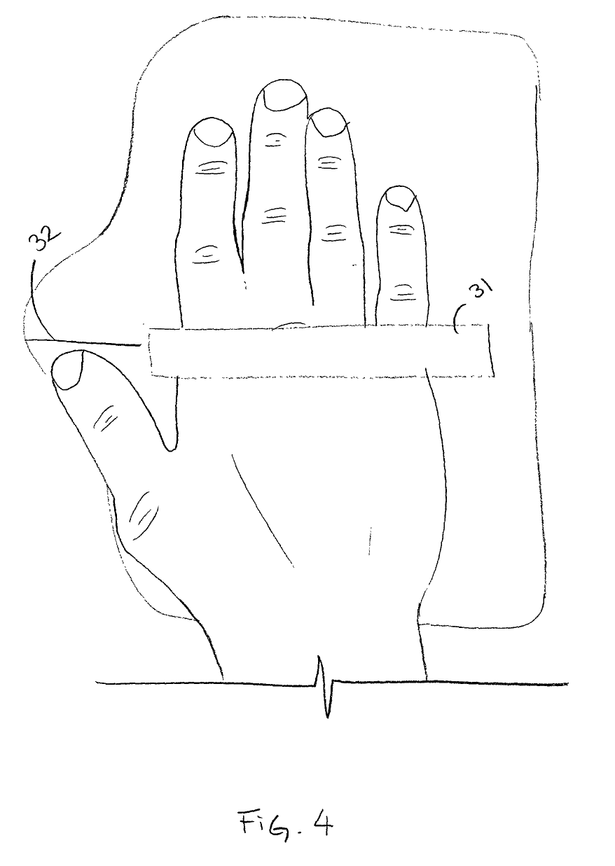

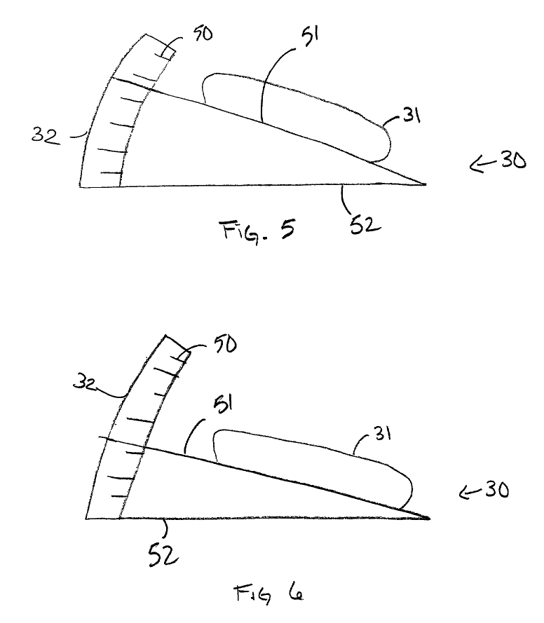

FIG. 3 is the plan view of a pronation gauge 30 in accord with one embodiment of the present invention. As mentioned above, pronation is the natural twist of a user's hands and arms when they are in a neutral or resting position. The pronation gauge 30 in this embodiment may be used to calculate the natural pronation of an individual user. The gauge in this embodiment may be made from a rigid paper product as well as numerous other materials including plastics, glasses, and metals. This gauge may be provided to the user with the keyboard or may be acquired by the user at a later time.

The pronation gauge 30 in this embodiment has a strap 31 and a vertical gauge 32 visible on its top surface. In use, a typist may lay the pronation guide flat on a work surface and, then, place either hand, thumb facing the vertical gauge 32, into the strap 31. The user may then relax their hand and wrist allowing them to rotate. As they rotate, the top plane of the pronation gauge will be lifted and a measurement of the natural pronation of the user can be taken from the gauge 32. If the measurements for each hand match one another that measurement may be used, if they do not, the average of the two readings may be used to adjust the keyboard.

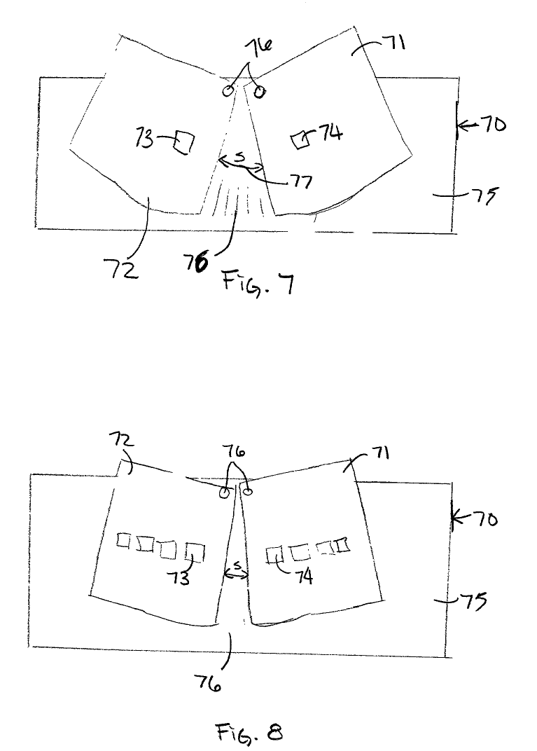

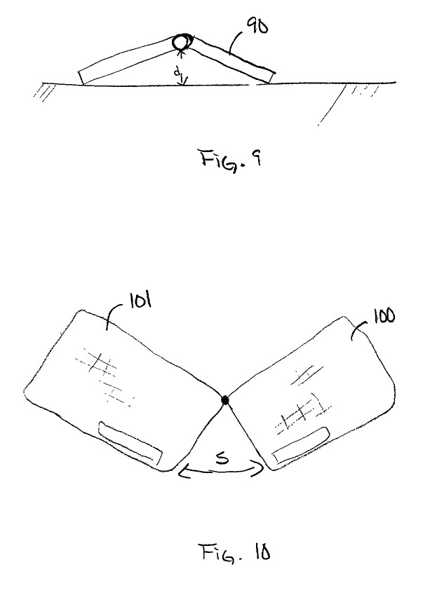

FIG. 4 illustrates how a user may insert his right hand into the strap 31 of the pronation gauge 30 in accord with one embodiment of the present invention.

FIG. 5 and FIG. 6 are side views of a pronation gauge 30 in use, measuring the natural pronation of a user. In both of these figures the hand of a user is not shown for ease of illustration. In FIG. 5 the top plane 51 of the pronation gauge 30 has been lifted by the user's hand after the user has allowed his hand to rotate to its natural resting orientation. This top plane 51 extends past the vertical gauge 32 and indicates a degree of pronation relative to the bottom plane 52 via the striation markings on the surface of the vertical gauge 32. These striation marks 50 may indicate actual degrees, general keyboard height or any other suitable measure that may be used to adjust or calibrate an adjustable keyboard. In one embodiment, the striations are specifically calibrated for a specific keyboard and indicate the height above the work surface that the specific keyboard should be positioned to accommodate the natural pronation of the user. FIG. 6 is the same pronation gauge 30 as described above but is shown at a different angle of pronation.

In either case, once the user obtains his recommended keyboard height he may, then, adjust the keyboard to that height and adopt that height or continue to adjust it to a more comfortable height with the benefit of the knowledge of the suggested setting.

In addition to the gauge described above, other embodiments are also plausible. For example, rather than using the vertical scale 32 a dial indicator may be used, the dial indicator being located at the intersection of the top plane 51 and the bottom plane 52 or somewhere else in the gauge 30.

The pronation gauge in this embodiment may be used in isolation to generate a suggested height for a keyboard or it may also be used in conjunction with a splay gauge or other calibration device to further guide the user towards a recommended adjustment setting.

In another embodiment of the present invention a splay indicator may be employed by a user to provide a suggested angle between two pivoting sections of a keyboard. As mentioned above, splay is the natural angle of a user's hands to each other when his hands are “inside” the width of his shoulders, as they would be when typing on a computer keyboard. The splay indicator may be a table using measurements of the user's arm length and shoulder width to determine a specific splay. Alternatively, the splay indicator may be a simulated keyboard having pivoting keyboard sections. Both of these embodiments are described below.

In one embodiment, of the splay indicator, one that employs a table or chart, a user may take measurements of his arms and shoulder width and may then apply these measurements to the table or chart to determine a suggested degree of splay. The user may then adjust the keyboard to this suggested splay angle or may further adjust the keyboard with the benefit of the suggested splay angle.

This manual or table method first requires the user to measure their shoulder width by placing a ruler on a flat work surface in front of them. The user may then place his forearms parallel to each other on the ruler. The user may then record the position of his middle finger on each of his hands and he may then calculate the distance between these two fingers. This calculated distance is his shoulder width. Next, the user may measure his arm length by placing an arm on the ruler and measuring from his elbow to the tip of his middle finger. This distance would represent his arm length. The user may then read a chart plotting arm length along one axis and shoulder width along the other axis to determine the suggested angle of splay. One exemplary formula that may be used to generate this chart is as follows (where the 125 mm is the approximate distance between the Z and the M keys on a standard keyboard):

(2)(arctan(((shoulder width−125)/2)(length of the arm)(180/π))).

Once the user has determined the suggested splay, he may then adjust the keyboard to that setting. He may also verify the setting with an individual splay indicator. As described in more detail below, the user may fine tune his suggested splay setting with the individual splay indicator and may, then, calibrate his keyboard to this revised setting. Moreover, even with this newly adjusted setting he may still choose to adjust the keyboard further to make it more comfortable to him, this adjustment being made with the benefit of the table's suggestion and the individual splay indicator's suggestion.

FIG. 7 and FIG. 8 are plan views of an individual splay indicator, as discussed above, in accord with an alternative embodiment of the present invention. In these figures pivot grommets 76, pivoting sections 71 and 72, ruler 70, back face 75, splay angle striations 76, and splay angle 77 are clearly visible. Consistent with the above discussion, once a user is aware of his suggested splay angle he may verify its level of comfort by positioning the pivoting sections 71 and 72 of the individual splay indicator to have the same splay angle suggested by the chart and, then, by placing his hands on the pivoting sections, aligning his fingers with the proper keys 73 and 74 as he would on a regular typewriter. After positioning his hands he may pivot sections 71 and 72, being careful to keep his hands aligned on the proper keys, to find the most comfortable setting. Once this setting was identified, he may then adjust the keyboard to this particular setting. Alternatively the user may compare the settings from the individual splay indicator and the manual method and average them to generate a setting for the keyboard.

FIG. 9 is a side view of a sectional ergonomic keyboard 90 with its center section raised a distance “d” off of the work surface in order to accommodate the angle of pronation of the user, as may be determined by one of the embodiments described herein.

FIG. 10 is a plan view of a sectional keyboard having an angle “s” between its two sections, as may be adjusted and determined by one of the embodiments described herein.

In addition to the above described embodiments other embodiments are also plausible. For example, the above described methods and systems may be used in conjunction with each other to calibrate both the splay and the pronation of an adjustable keyboard. Such a calibration “kit” could be provided with the keyboard and could include, a splay chart; an individual splay indicator; a shoulder and arm ruler; and a pronation gauge.

Moreover, in another alternative embodiment, rather than using the above described mechanical gauges to determine the optimum position of an adjustable keyboard, electro-myography may, instead, be used. Here, the electro-myography may be used to measure the amount of stress being placed on the body by measuring the amount of contraction in the muscles for a given keyboard configuration and, then, to determine which splay and pronation positions place the least amount of stress on the muscles.

Therefore, while several embodiments of the present invention were discussed, other embodiments within the spirit and scope of the present invention are also possible.

What is claimed is:

1. A system for determining an initial suitable configuration of an adjustable keyboard for an individual user, the system comprising:
a pronation gauge, the pronation gauge having a readable scale,
the readable scale adapted to indicate a specific degree of pronation of the user's hand for a specific resting orientation of the user's hand within the gauge.

2. The system of claim 1 wherein the pronation gauge has a moveable platform in communication with the readable scale.

3. The system of claim 2 wherein the pronation gauge is an upright standard with a range of markings that indicate the specific angle of pronation of the user's hand for a specific angle of the moveable platform.

4. The system of claim 1 further comprising:
a splay indicator,
the splay indicator adapted to indicate the degree of splay for a specific user after the user's hands have been placed on the splay indicator.

5. The system of claim 4 wherein the splay indicator has a first pivoting section and a second pivoting section, the first pivoting section having a point marked for the user's right hand and the second pivoting section having a point marked for the user's left hand.

6. The system of claim 5 wherein the first pivoting section and the second pivoting section and pivotably mounted to a board having a first face and a second face, the board having striations on its first face that indicate the angle of splay for a given relative position of the first pivoting section and the second pivoting section.

7. The system of claim 6 wherein the board has uniform spaced striations on its second face.

8. The system of claim 4 wherein the splay indicator includes a sensor adapted to sense the relative positions of the user's hands placed on the sensor and to generate a first electronic signal indicating the user's hands relative positions.

9. The system of claim 8 further comprising:
a processor in communication with the sensor and adapted to receive the first electronic signal and determine the splay of the user's hands for that particular first electronic signal.

10. A method of determining an initial suitable configuration of an adjustable keyboard for an individual user, the method comprising:
measuring the resting pronation position of the user's first hand; and
adjusting the pronation orientation of the adjustable keyboard to a position that coincides with the measurement of the pronation position of the user's hand.

11. The method of claim 10 further comprising:
converting the measurement of the resting pronation position of the user's first hand from a unit of rotation to a unit of length.

12. The method of claim 10 further comprising:
measuring the resting splay position of the user's first hand relative to the user's second hand; and
adjusting the splay orientation of the adjustable keyboard to a position that coincides with the measurement of the pronation position of the user's hands.

13. The method of claim 10 further comprising:
using a chart to determine a splay setting for the user; and
adjusting the splay orientation of the adjustable keyboard to a position that coincides with the splay setting obtained from the chart.

14. The method of claim 13 further comprising:
measuring the shoulder width of the user; and
measuring the arm length of the user.

15. The method of claim 14 wherein the measurements are made with a ruler having a first side and a second side,
the first side having a plurality of uniformly spaced indicators and
the second side having a first template and a second template pivotably mounted on top of the second side.

16. The method of claim 10 further comprising:
measuring the resting pronation position of the user's second hand;
calculating the average of the measurement of the resting pronation position of the user's first hand and the measurement of the resting pronation position of the user's second hand; and
adjusting the pronation orientation of the adjustable keyboard to a position that coincides with the calculated average of the resting pronation positions of the user's first hand and the user's second hand.

17. The method of claim 16 further comprising:
adjusting the pronation orientation of the adjustable keyboard to a position that is different than the position that coincides with the calculated average of the resting pronation positions of the user's first hand and second hand.

18. The method of claim 13 whereas the chart represents solutions to the formula
(2)(arctan(((shoulder width−125)/2)(length of the arm)(180/π))),
where shoulder width is measured in mm and length of the arm is measured in mm.
